(19) United States
(12) Patent Application Publication
(10) Pub. No.: US 2008/0087813 A1
(43) Pub. Date: Apr. 17, 2008

(54) Multi source, multi path mass spectrometer

(75) Inventors: Harvey Dean Loucks, La Honda, CA (US); Gregory Paul Houtz, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Loveland, CO (US)

(21) Appl. No.: 11/549,536

(22) Filed: Oct. 13, 2006

(51) Int. Cl. H01J 49/00

(52) U.S. Cl. 250/287

(57) ABSTRACT

A mass spectrometer system includes a first mass spectrometer channel. The mass spectrometer system includes a second mass spectrometer channel. A housing is configured to enclose the first and second mass spectrometer channels within the same chamber. A mass analyzer is coupled with the first and second channels and configured to analyze ion streams received from the first and second channels.

### BACKGROUND OF THE INVENTION

The present invention relates generally to mass spectrometry systems and methods, and more particularly to systems and methods that allow for sharing components between two or more mass spectrometer systems.

Combining liquid chromatography (LC) or gas chromatography (GC) with mass spectrometry (MS) is a powerful approach to determining the concentration of target compounds in complex sample matrices. Samples may include biological fluids or environmental samples, among others.

When applying liquid or gas chromatography to a mix of compounds in a sample-containing matrix, the compounds are separated and elute from the chromatography system one after another in either a liquid or gas stream. The liquid or gas stream is then introduced into a mass spectrometer for mass spectrometric analysis. In the mass spectrometer, compounds are ionized with methods known in the art such as atmospheric pressure ionization (API), which is typical for LC/MS systems, and electron Impact Ionization (EII), which is typical for GC/MS systems. Other ionization sources may be used.

Mass spectrometer analysis can be significantly enhanced by performing two or more stages of mass analysis in tandem (MS/MS). In the most frequently used mode of MS/MS, ions of the target compound having a particular mass-to-charge ratio (m/z) are selected by a first mass analyzer in a first stage of mass analysis from among all the ions of various m/z values formed in the ion source. The selected ions are referred to as precursor ions, and the resulting distribution of ions is called the precursor mass spectrum which is the same spectrum produced in non-tandem instruments.

Between the two stages of analysis, the ions are typically subjected to some mass changing reaction, such as collision-induced dissociation (CID) or collisionally activated dissociation (CAD), so that the succeeding mass analyzer has a different distribution of m/z values to analyze. To that end, the precursor ions are directed into a collision cell where they are energized, typically by collision with a neutral gas molecule, to induce ion dissociation and transition into fragment ions.

In the second stage of mass analysis, the fragment ions and any undissociated precursor ions pass into a second mass analyzer, such as a quadrupole analyzer, ion trap analyzer, time-of-fight analyzer or other analyzer using electromagnetic fields and ion optics. For each of the precursor ion entities, there is a corresponding distribution of reaction product ions called the product ion spectrum. The ions eventually interact with a detector system including signal processing electronics that record an ion mass spectrum at regular time intervals throughout the chromatographic separation. When the ion intensity for all combinations of the precursor and product m/z values is measured, a three dimensional array of data (precursor m/z vs. product m/z vs. intensity), commonly referred to as GC/MS/MS or LC/MS/MS data set, is produced. From each data set, mixtures of ions can be resolved without prior separation of their molecules and a great deal of structural information about individual compounds may be obtained. Tandem MS/MS instruments greatly enhance detection specificity over single-stage mass spectrometers, since ions appearing in a combination of precursor m/z and product m/z values are more specific to a particular analyte than just the precursor m/z value as given in non-tandem instruments.

While the above developments have provided significant advances in mass spectrometry, further improvements are desirable. For example, conventional MS/MS instruments typically cannot keep information about the precursor m/z after the ion is fragmented. Thus, one must fragment ions of only one m/z value at a time, passing the fragments of the selected m/z value ions on to the second stage of mass analysis. Regardless of the type of mass analyzer used for the first stage of MS in an MS/MS experiment, the first stage is used as a mass ‘filter’ in that only ions of a narrow range of m/z values are accepted from the first stage at one time. To obtain the product spectrum from ions that have other m/z values, the experiment must be repeated to produce ions from each different precursor m/z value. To achieve high throughput it is common for many different MS/MS instruments to be present in one laboratory to enable experiments to run on samples for several different target precursor m/z values at once, or more commonly to enable multiple samples to be run simultaneously.

However, acquiring several different MS/MS systems for one laboratory can be very inefficient. For example, the TOF analyzer is a complex instrument with many costly components such as machine base plates, electronics, vacuum manifolds, vacuum pumps, feedthrough devices, ion transport multipoles and pulser and mirror optics. It can also be wasteful to run different samples simultaneously on different machines if some of the ion optic components on the different machines provide identical functions and if the operation lifetimes are relatively long. Thus, it would be desirable to reduce the cost and/or increase the efficiency and throughput of multiple MS/MS systems. In particular, it would be desirable to provide the analytic capacity of two or more MS/MS systems for less than the cost of two or more MS/MS systems.

### BRIEF SUMMARY OF THE INVENTION

The present invention relates generally to mass spectrometer systems, and more particularly to systems that provide two or more mass spectrometer systems in a single instrument.

According to an embodiment of the invention, a mass spectrometer system includes a first mass spectrometer channel. The mass spectrometer system includes a second mass spectrometer channel. In general, a channel is defined by the flight path of ions as controlled by the various mass spectrometer components. A housing is configured to enclose the first and second mass spectrometer channels (and mass spectrometer components) within the same chamber. A mass analyzer is coupled with the first and second channels and configured to analyze ion streams received from the first and second channels. In one aspect, the mass analyzer is configured to analyze ion streams received from the first and second channels simultaneously. In another aspect, the mass analyzer comprises a pulsing device that receives a first ion stream from the first channel and a second ion stream from the second channel and delivers pulses of ions from the first or second ion stream into a flight tube in ascending order of their atomic mass.

According to another embodiment of the invention, a mass spectrometer includes a first ion source that produces ions in a first ion stream. A first ion guide receives and transfers ions in the first ion stream from the first ion source. A first cell receives and dissociates ions in the first ion stream from the first ion guide. A second ion source produces ions in a second ion stream. A second ion guide receives and transfers ions in the second ion stream from the second ion source. A second cell receives and dissociates ions in the second ion stream from the second ion guide. A mass analyzer receives the dissociated and undissociated ions in the first and second streams from the first and second cells. In one aspect, a third ion source produces ions in a third ion stream, and a third cell receives and dissociates the ions in the third ion stream. In another aspect, a second mass analyzer receives the dissociated and undissociated ions in the third ion stream. In another aspect, a fourth ion source produces ions in a fourth ion stream, a fourth cell receives and dissociates the ions in the fourth ion stream; and the second mass analyzer receives the dissociated and undissociated ions in the fourth ion stream.

### BRIEF DESCRIPTION OF THE DRAWINGS

FIG. 1 shows a mass spectrometer system with shared components according to an exemplary embodiment of the invention.

### DETAILED DESCRIPTION OF THE INVENTION

Embodiments of the invention allow for two or more mass spectrometry systems to be contained in a single housing structure or chassis, including a single mass analyzer. For example, two or more MS/MS systems defining different MS channels may be provided in one instrument. Embodiments therefore advantageously saves cost and/or increases efficiency by allowing for shared components, e.g., sharing a single set of vacuum pumps, ion optics (and associated electronics), data acquisition electronics, and/or other hardware and industrial design.

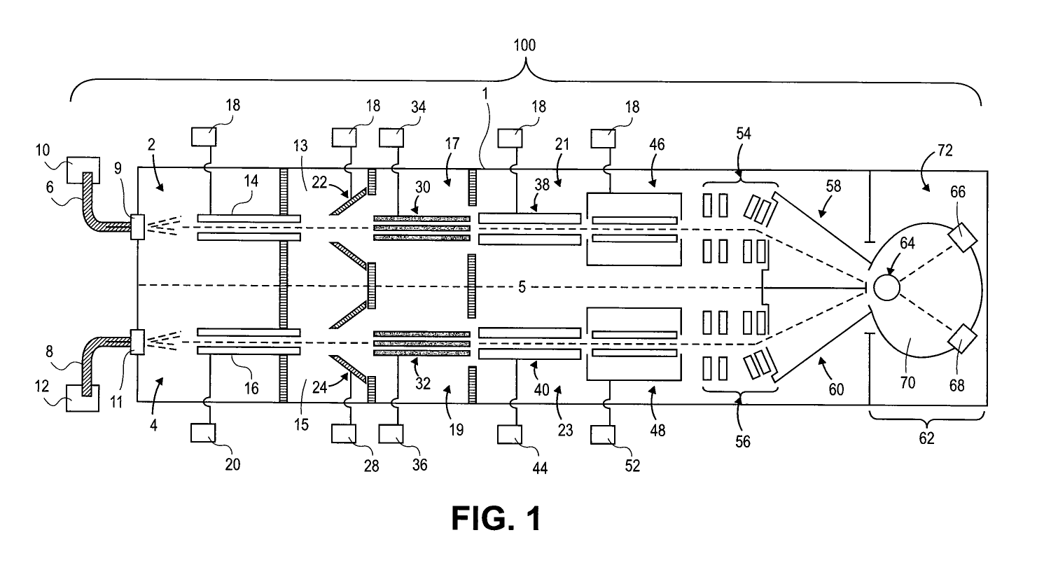

FIG. 1 shows a mass spectrometer system with shared components according to one embodiment. The system 100 shown includes a housing structure 1 that defines a chamber 5, within which two or more MS systems are housed. Each MS system is defined by an ion or MS channel extending from an ion source to an analyzer portion. A MS channel may include various components that control the flight path of ions, such as a first ion guide 30, a collision cell 46, a second ion guide 38 and a mass analyzer 62. In general, a MS channel is defined by the flight path of ions as controlled by the various MS components. As shown in FIG. 1, for example, two ion channels extend from ion sources to analyzer 62. A first channel extends from a first ion source 9 to analyzer 62, and a second channel extends from a second ion source 11 to analyzer 62. Chamber 5 may comprise a single chamber or it may comprise various sub-chambers (e.g., chambers 17 and 19, 21 and 23, etc. as will be further described later). In certain embodiments, analyzer 62 is configured with two (or more) detectors to allow for simultaneous analysis of ions from two (or more) mass spectrometer channels as will be discussed below.

In one embodiment of the invention, sample source 10 includes an analytical separation device 6 that provides a liquid containing a sample of interest to sample sprayer 9. Similarly, sample source 10 may include an analytical separation device 8 that provides a liquid containing a sample of interest to sample sprayer 11. A sample may be any liquid material, including dissolved solids, or mixture of materials dissolved in a solvent. Samples typically contain one or more components of interest, and may be derived from a variety of sources such as foodstuffs or environmental materials, such as waste water, soil or crop. Samples may also include biological samples such as tissue or fluid isolated from a subject (e.g., a plant or animal), including but not limited to plasma, serum, spinal fluid, semen, lymph fluid, external sections of skin, respiratory, intestinal and genitourinary tracts, tears, saliva, milk, blood cells, tumors, organs and also samples of in vitro cell culture constituents, or any biochemical fraction thereof. Samples may also include synthesized organic and inorganic molecules, or manufactured chemicals. Useful samples might also include calibration standards or reference mass standards.

The analyte sample(s) is supplied in a stream to ion sources 9 and 11 by analytical separation devices 6 and 8 by means well known in the art, and may be in liquid or gas form. The method of ionization may vary. However, one mode of sample introduction for medium and large molecules in tandem mass spectrometry is liquid chromatography (LC/MS/MS), by which sample components are sorted according to their retention time on a column through which they pass. The various compounds that leave columns 6 and 8 and flow into ionization regions 2 and 4 are present for some tens of seconds or less, which is the amount of time available to obtain all the information about an eluting compound. Since compounds often overlap in their elution, rapid spectral generation as provided by LC/MS/MS may enable rapidly generating each compound's elution profile and allow overlapping compounds to be separately identified.

Analytical separation devices 6 and 8 can be any liquid chromatograph (LC) device including but not limited to a high performance liquid chromatograph (HPLC), a micro- or nano-liquid chromatograph, an ultra high pressure liquid chromatography (UHPLC) device, a capillary electrophoresis (CE), or a capillary electrophoresis chromatograph (CEC) device. However, any manual or automated injection or dispensing pump system may be used. For example, in some embodiments, a liquid stream may be provided by means of a nano- or micro-pump.

A continuous stream of sample provided by analytical separation devices 6 and 8 are then ionized by devices 9 and 11, respectively. Devices 9 and 11 may be any ion source known in the art used for generating ions from an analyte sample. Examples include atmospheric pressure ionization (API) sources, such as electrospray (ESI), atmospheric pressure chemical ionization (APCI) and atmospheric pressure photoionization (APPI) sources. Other ion sources may be used.

FIG. 1 shows that the ion stream from device 9 is separate from the ion stream from device 11, so that the ions from each source may be independently produced but transferred into the same mass spectrometer system. In one embodiment of the invention, the first and second channels are housed in a single chamber. In another embodiment, a dividing wall is provided to separate the first channel from the second channel into two chambers. In another embodiment the separation is maintained by physical space and or electric fields.

Ions leaving sample sprayers 9 and 11 are respectively directed to transfer capillaries 14 and 16 that transfer ions toward the mass analyzer and allow a reduction of gas pressure from that of the ionization source chambers 2 and 4. Pressure may be reduced by one or more vacuum chambers, such as a single shared vacuum chamber, or if separate chambers are used, by separate vacuum chambers 13 and 15. Capillary 14 or 16 may be a tube, a passageway or any other such device for ion transport and pressure reduction. The mass spectrometer system in FIG. 1 further includes chambers 17 and 21 and chambers 19 and 23. The chambers are separately pumped by vacuum pumps with ions being transported through various vacuum stages of decreasing pressure until the lowest pressure is reached in a mass analyzer (e.g., vacuum chamber 72 in FIG. 1). Typically, while sprayers 9 and 11 are held at ambient pressure, vacuum chambers 13 and 15 are held at a pressure of about two to two and a half orders of magnitude less than ambient pressure, and the mass analyzer is held at a pressure of about six to seven orders of magnitude less than that of the chambers 13 and 15. In one embodiment, each pair of similar vacuum stages (i.e., chambers/stages 13 and 15, 17 and 19, etc.) are pumped by one stage of a vacuum pump. The ions are swept into vacuum chambers 17 and 19 due to the pressure difference between vacuum stages 13 and 15 and chambers 17 and 19, and due to applied electric potentials.

The ions exit transfer capillaries 14 and 16 in a continuous beam and respectively pass through skimmers 22 and 24 that focus and direct the ions toward a mass analyzer. FIG. 1 shows skimmer 22 dividing chamber 13 from chamber 17, and skimmer 24 dividing chamber 15 from chamber 19. Skimmers 22 and 24 are known in the art to enrich analyte ions relative to neutral molecules such a solvent or gases contained in the ion beams exiting transfer capillaries 14 and 16 prior to their entries into the ion transfer optics (e.g., an ion guide, ion beam shaping or focusing lenses or the like). The ions from the first and second channels then enter first or preliminary ion guides in continuous beams.

FIG. 1 shows first or preliminary ion guides 30 and 32 in chambers 17 and 19, respectively. According to an exemplary embodiment of the invention, first ion guides 30 and 32 are octapole ion guides and are driven by power sources 34 and 36. In the embodiment shown in FIG. 1, the capillaries, skimmers, or ion guides in the first and second channels ( e.g., octopoles 30 and 32) are respectively driven by separate power sources (e.g., power sources 34 and 36). In another embodiment of the invention, the capillaries, skimmers, and/or ion guides in the first and second channels are driven by common or shared power sources. Ion guides 30 and 32 may also be a radio frequency (RF) ion guide or any other type of ion guide, a stacked ring ion guide or an ion lens system. Ion guides 30 and 32 may also include a multipole structure if the power sources 34 and 36 are RF and/or DC power supplies. Other ion guiding or controlling devices may be used.

After ions travel along preliminary or ion paths through first ion guides 30 and 32, they are pushed or directed into second ion guides 38 and 40 in chambers 21 and 23, respectively. As shown in FIG. 1, second ion guides 38 and 40 are driven by power sources 42 and 44 and may be any of the above types of ion guides. According to an exemplary embodiment of the invention, second ion guides 38 and 40 are quadrupoles. Other embodiments of the invention may eliminate one set of ion guides, such as first ion guides 30 and 32.

FIG. 1 shows collision cells 46 and 48 following second ion guides 38 and 40. The ions exiting ion guides 38 and 40 are “precursor” ions, and collision cells 46 and 48 allow the precursor ions to undergo reactions (e.g., fragmentation, charge stripping, EDT, m/z changing collisions, etc.) prior to entering a mass analyzer. The precursor ions are energized in collision cells 46 and 48 typically by collisions with a neutral gas molecule, such as nitrogen, helium, xenon or argon. The precursor ions are consequently dissociated into fragment ions, having a different distribution of m/z values for the mass analyzer to analyze.

FIG. 1 shows other beam optics 54 and 56 that may also be included to refocus the ion beams before they enter a mass analyzer. For example, other beam optics may also include an electric lens having an aperture, or a multiple component beam optics system. The beam optics may also include an ion lens that serves as a refocusing element to direct the ion beam into a mass analyzer. Refocusing may be accomplished by any number of ion lenses known in the art. It may be accomplished, for example, by an aperture lens, a system of aperture lenses, one or more einzel lenses, a dc quadrapole lens system, a multipole lens, a cylinder lens or system thereof, or any combination of the above lenses.

According to one embodiment, the same mass analyzer 62 is used for simultaneously analyzing ions from both first and second channels of the mass spectrometer system, corresponding the separate flight paths of ions from ion sources 2 and 4. The fragment ions and any undissociated precursor ions from either the first flight path of ion source 2 or the second flight path of ion source 4 pass through beam converging slicers 58 and 60 into the same mass analyzer 62, which determines the m/z ratio of the ions to determine molecular weights of analytes in the samples.

Beam converging slicers 58 and 60 are beam optic devices that include apertures or slits that transfer ions with high energy into flight tube 72. In one aspect, beam converging slicers 58 and 60 are two separate apertures placed adjacent to each other. In another aspect, beam converging slicers 58 and 60 are parts of a single aperture wide enough to accept ions from both MS channels. A wider aperture may be placed closer to pulser 64 to be shared by the two channels for introducing ions from both channels to mass analyzer 62. In another aspect, the apertures of beam optics devices 58 and 60 may be stacked on top of one another along the axis of flight tube 72, instead of being positioned adjacent to each other. However, positioning the apertures adjacent to each other is preferable in order to reduce the spatial and energy distribution of the ions along the axis of the flight tube, which improves the resolution of the mass spectrometry. The energy differences between the ions on their flight in flight tube 72 and on the path preceding pulser 64 do not affect resolution, assuming that the detectors are positioned in their proper locations to detect the ions and that the ions are not close to any fringe fields in pulser 64 or the ion mirror (not shown) of mass analyzer 62.

Moreover, while FIG. 1 shows a single bend for each ion beam at each MS channel's beam optics device 54 or 56, multiple bends of the ion beam are also possible, as is bending the ion beam after it exits beam optics device 54 or 56. In another aspect, having the two MS channels being positioned at an angle with respect to each other, rather than being parallel as shown in FIG. 1, makes it possible to avoid bending the ion beams entirely. However, such an embodiment may increase the size and cost of the vacuum system. While FIG. 1 also indicates that the ion beams cross at pulser 64, the beams may also cross at slicers 54 or 56, or the ion mirror (not shown) in the flight tube. In yet another aspect, the beams from the two channels may be parallel to each other without crossing at all.

Tandem mass spectrometers may include multiple mass analyzers operating sequentially in space or a single mass analyzer operating sequentially in time. Mass spectrometers that can be coupled to a gas or liquid chromatograph include the triple quadrupole mass spectrometer, which is widely used for tandem-in-space mass spectrometry. However, one limitation in the triple quadrupole system is that recording a fragment mass spectrum can be time consuming because the second mass analyzer must step through many masses to record a complete spectrum. To overcome this limitation, the second mass analyzer may be replaced by a time-of-flight (TOF) analyzer. One advantage of the TOF analyzer is that it can record up to 10⁴ or more complete mass spectra every second. Thus, for applications where a complete mass spectrum of fragment ions is desired, the duty cycle is greatly improved with a TOF mass analyzer and spectra can be acquired more quickly. That is, the TOF analyzer can produce product spectra at such a high rate that the full MS/MS spectrum can be obtained in one slow sweep of the quadrupole mass analyzer. Alternatively, for a given measurement time, spectra can be acquired on a smaller amount of sample.

According to one embodiment of the invention, mass analyzer 62 includes a TOF analyzer. As shown in FIG. 1, TOF analyzer 62 includes pulser 64 and detectors 66 and 68. Focused ions enter pulser 64, which pulses the ions with a voltage and sends the ions in a flight tube 70 in TOF analyzer 62. Detectors 66 and 68 are positioned to detect ions in their respective channels. In certain aspects, the TOF with an ion mirror may be used, in which case the pulsed ions enter an ion mirror (not shown) and are reflected onto the detectors 66 and 68 at the end of flight tube 70. Since all of the pulsed ions have substantially the same energy, the flight time of ions depends only on their m/z. The mass is determined by a signal processing system (not shown), that records separate data files for the first channel corresponding the ion stream from ion source 2 and the second channel corresponding the ion stream from ion source 4.

Ions have different velocities due to different mass-to-charge ratios (m/z) when accelerated in a vacuum by an electric field. Detectors 66 and 68 measure the time required for the ion to reach the detector after acceleration to determine this velocity at the end of the flight path in flight tube 70. For a known distance d between the acceleration region and the detector, and a flight time t between the times of acceleration and detection, the velocity v will be v =d/t (note that where a TOF includes a mirror element, the equation will differ as is well known to one of skill in the art) (note also that since the pulser does not create an infinite gradient, finite time is spent accelerating and this must also modify the equation). Since the distance is approximately the same for all ions, their arrival times differ with smaller m/z ions reaching the detector first and larger m/z ions later. Signal processing electronics then record an ion mass spectrum at time intervals, in a three-dimensional LC/MS/MS or GC/MS/MS data sets.

According to an embodiment of the invention, the analyses of ions from multiple flight paths are simultaneous since the space charge density of the ions is low enough to limit ion interaction from the different flight paths. In other embodiments of the invention, three or four different channels from three or four different ion sources may be provided in the same MS or MS/MS instrument and share the same TOF analyzer. In yet other embodiments of the invention, three or four or more channels from corresponding ion sources may be provided in the same MS/MS instrument and share two TOF analyzers.

Embodiments of the invention provide the advantages of two or more mass spectrometry systems in a single chassis, using a single mass analyzer. Providing two or more MS/MS systems defining different channels in one instrument saves cost by requiring only a single set of vacuum pumps, ion optics, data acquisition electronics, other hardware and industrial design. Two or more MS/MS systems could be obtained for a reduced cost, e.g., approaching the cost of only one system, or three or four MS/MS systems for the cost of two. Additionally, providing two or more MS/MS channels in one instrument saves the time to run two (or more) different analyses at different times, since the single instrument provides for separate functions while sharing much of the electronics and hardware.

A variety of different mass analyzers using electromagnetic fields and ion optics may be part of the mass spectrometer system in other embodiments of the invention, such as a quadrupole analyzer, a reflectron time of flight analyzer, an ion trap analyzer, an ion cyclotron mass spectrometer, Fourier transform ion cyclotron resonance (FTICR), a single magnetic sector analyzer, and a double focusing two sector mass analyzer having an electric sector and a magnetic sector. Other spectrometry systems and variations as known in the art may be used, such as for example coupling electrospray ionization (ESI) to TOF mass spectrometry (TOFMS). Other variations on the TOFMS include subjecting all the precursor ions to the fragmentation mechanism without preselection and determining the product mass with subsequent acceleration. Recent proposals also include resonant excitation in RF-only quadrupoles for CID with fragment mass analysis by TOFMS.

While the present invention has been described with reference to the specific embodiments disclosed, the invention is not limited to any particular implementation disclosed herein. For example, a radio frequency ion guide may be a quadrupole, hexapole or other multipole device, as well as a structure of rings or a multipole sliced into several segments as well known in the art. Additionally, it should be appreciated that mass spectrometer channels may be arranged in parallel, and at various different angles relative to each other. It should be understood by those skilled in the art that various changes may be made and equivalents substituted without departing from the spirit and scope of the invention. In addition, many modifications may be made to adapt a particular situation, material, composition of matter, process, process steps, to the objective, spirit and scope of the present invention. All such modifications are intended to be within the scope of the claims appended hereto.

1. A mass spectrometer system comprising:
a housing having a first mass spectrometer channel and a second mass spectrometer channel; and
a mass analyzer coupled with the first mass spectrometer channel and the second mass spectrometer channel and configured to analyze ions received from the first mass spectrometer channel and the second mass spectrometer channel.

2. The mass spectrometer system of claim 1, further comprising:
a first ion source that produces ions in a first ion stream, wherein the first ion source is coupled with the first mass spectrometer channel; and
a second ion source that produces ions in a second ion stream, wherein the second ion source is coupled with the second mass spectrometer channel.

3. The mass spectrometer system of claim 1, wherein the mass analyzer is configured to analyze ion streams received from the first and second channels simultaneously.

4. The mass spectrometer system of claim 1, wherein the mass analyzer comprises a pulsing device that receives ions in a first ion stream from the first channel and ions in a second ion stream from the second channel and delivers pulses of ions from the first or second ion stream into a flight tube in ascending order of their atomic mass.

5. The mass spectrometer system of claim 2, wherein the mass analyzer comprises a first ion detector associated with the first channel and a second ion detector associated with the second channel.

6. The mass spectrometer system of claim 3, wherein the first detector detects time of arrival of ions in the flight tube from the first channel, and the second detector detects time of arrival of ions in the flight tube from the second channel.

7. The mass spectrometer system of claim 4, further comprising a signal processor configured to generate an ion mass spectrum for the first and/or second channel.

8. The mass spectrometer system of claim 1, wherein the first ion source ionizes a first sample and the second ion source ionizes a second sample.

9. The mass spectrometer system of claim 6, further comprising a first separation device that introduces the first sample into the first ion source from a first supply stream and a second separation device that introduces the second sample into the second ion source from a second supply stream.

10. The mass spectrometer system of claim 6, wherein the first channel comprises a first capillary to transfer ions in the first ion stream to a first ion guide, and the second channel comprises a second capillary to transfer ions in the second ion stream to a second ion guide.

11. The mass spectrometer system of claim 8, wherein the first channel further comprises a first skimmer between the first capillary and the first ion guide, and the second channel further comprises a second skimmer between the second capillary and the second ion guide.

12. The mass spectrometer system of claim 9, wherein the first channel further comprises a first collision cell receiving ions in the first ion stream from the first ion guide, and the second channel further comprises a second collision cell receiving ions in the second ion stream from the second ion guide, the collision cells being configured to dissociate the ions from the ion streams into ion fragments.

13. The mass spectrometer system of claim 9, wherein the first channel further comprises a third ion guide receiving ions in the first ion stream from the first ion guide, and the second channel further comprises a fourth ion guide receiving ions in the second ion stream from the second ion guide.

14. The mass spectrometer system of claim 11, wherein the first channel further comprises a first collision cell receiving ions in the first ion stream from the third ion guide, and the second channel further comprises a second collision cell receiving ions in the second ion stream from the fourth ion guide, the collision cells being configured to dissociate the ions into fragment ions.

15. The mass spectrometer system of claim 10, wherein the first channel further comprises a first focusing means for focusing the fragment ions and undissociated ions from the first collision cell and the second channel further comprises a second focusing means for focusing the fragment ions and undissociated ions from the second collision cell.

16. The mass spectrometer system of claim 13, wherein the first channel further comprises a first beam converging slicer that introduces ions in the first ion stream into the mass analyzer, and the second channel further comprises a second beam converging slicer that introduces ions in the second ion stream into the mass analyzer.

17. The mass spectrometer system of claim 1, further comprising a third ion source that produces ions in a third ion stream, wherein the third ion source is coupled with a third channel, and the third channel is coupled with the mass analyzer.

18. The mass spectrometer system of claim 15, further comprising a fourth ion source that produces ions in a fourth ion stream, wherein the fourth ion source is coupled with a fourth channel, and the fourth channel is coupled with the mass analyzer.

19. The mass spectrometer system of claim 1, further comprising at least one vacuum pump that decreases pressure from pressure in the first and second ion sources to pressure in the mass analyzer.

20-29. (canceled)

30. The mass spectrometer system of claim 1, wherein the mass analyzer is a time-of-flight analyzer.

31-42. (canceled)
